(19) United States
(12) Patent Application Publication
(10) Pub. No.: US 2021/0344016 A1
(43) Pub. Date: Nov. 4, 2021

(54) NEGATIVE ELECTRODE FOR NONAQUEOUS ELECTROLYTE SECONDARY BATTERIES AND BATTERY THEREOF

(71) Applicant: KANEKA CORPORATION, Osaka (JP)

(72) Inventor: Masato Kuratsu, Osaka (JP)

(73) Assignee: KANEKA CORPORATION, Osaka (JP)

(21) Appl. No.: 17/370,125

(22) Filed: Jul. 8, 2021

Related U.S. Application Data
(63) Continuation of application No. PCT/JP2019/039912, filed on Oct. 9, 2019.

(30) Foreign Application Priority Data
Jan. 8, 2019 (JP) 2019-001382

(51) Int. Cl. H01M 4/62; H01M 10/0525; H01M 4/131; H01M 4/485

(52) U.S. Cl. CPC H01M 4/625; H01M 10/0525; B82Y 30/00; H01M 4/485; H01M 4/621; H01M 4/131

(57) ABSTRACT

[Problem]

Repeated charge and discharge of a nonaqueous electrolyte secondary battery result in gas generation and thus a reduction in the battery capacity.

[Solving Means]

The problem can be solved by providing a negative electrode for nonaqueous electrolyte secondary batteries including a negative electrode active material having an average operating potential of 0.5 V (vs. Li/Li⁺) or more and less than 2.0 V (vs. Li/Li⁺) during desorption and insertion of lithium ions, a conductive aid that is carbon nanotubes having a diameter of 100 nm or less, and a binder that is macromolecules having acidic functional groups.

### TECHNICAL FIELD

The present invention relates to a negative electrode for nonaqueous electrolyte secondary batteries and a battery thereof.

### BACKGROUND ART

Nonaqueous electrolyte secondary batteries are being used in portable devices, hybrid vehicles, electric vehicles, household storage batteries, and the like and are required to have multiple characteristics, such as electric capacity, safety, and operation stability, in a well-balanced manner.

For example, a nonaqueous electrolyte secondary battery has been developed in which lithium titanate is used as a negative electrode active material, vapor-grown carbon fibers having an average fiber length of 1 to 5 μm are used as a conductive aid for a negative electrode, and a polyacrylic acid is used as a binder for the negative electrode (Patent Literature 1). This nonaqueous electrolyte secondary battery reduces the resistance of the negative electrode by using the vapor-grown carbon fibers having higher conductivity than conventionally used conductive aids (for example, graphite and acetylene black) and improves the adhesion between the active material and the vapor-grown carbon fibers by using the vapor-grown carbon fibers having a specific length and the specific polyacrylic acid in combination. Thus, this nonaqueous electrolyte secondary battery is able to suppress an increase in the internal resistance of the battery due to structural collapse of the negative electrode even in a harsh humid environment.

### CITATION LIST

### Patent Literature

Patent Literature 1: Japanese Unexamined Patent Application Publication No. 2012-69454

### SUMMARY OF INVENTION

### Technical Problem

Conventionally, a nonaqueous electrolyte secondary battery using lithium titanate as a negative electrode active material has a problem that repeated charge and discharge causes the reaction between lithium titanate and an electrolyte and thus decomposition of the electrolyte and gas generation. While Patent Literature 1 is able to suppress an increase in the resistance due to structural collapse of the negative electrode, it still has a challenge of suppressing gas generation caused by actual repetition of charge and discharge and has room for improvement.

### Solution to Problem

To solve the above problem, the present inventors focused on and intensively investigated the state of a conductive network formed in an electrode. As a result, the present inventors found that use of vapor-grown carbon fibers having a prescribed diameter (may be referred to as the carbon nanotubes) as a conductive aid, use of macromolecules having acidic functional groups as a binder, and use of the carbon nanotubes and the macromolecules at a specific weight ratio improve dispersibility of a negative electrode active material, the carbon nanotubes, and the macromolecules and suppress gas generation caused by repeated charge and discharge, as well as allow for obtaining a nonaqueous electrolyte secondary battery having excellent cycle stability and high input-output characteristics, and completed the present invention based on this finding.

That is, the present invention provides a negative electrode for nonaqueous electrolyte secondary batteries. The nonaqueous electrolyte secondary battery includes a negative electrode active material, a conductive aid, and a binder. The negative electrode active material has an average operating potential of 0.5 V vs. Li/Li⁺ or more and less than 2.0 V vs. Li/Li⁺ during desorption and insertion of lithium ions. The conductive aid contains an amount of 0.05 percent by weight or more and 2 percent by weight or less of carbon nanotubes having a diameter of 100 nm or less with respect to the total weight of the negative electrode active material, the conductive aid, and the binder. The binder contains 2 percent by weight or more and 8 percent by weight or less of macromolecules having acidic functional groups with respect to the total weight of the negative electrode active material, the conductive aid, and the binder.

### Advantageous Effects of Invention

The negative electrode for nonaqueous electrolyte secondary batteries according to the present invention uses the carbon nanotubes having the predetermined diameter as the conductive aid for the negative electrode and the macromolecules having the acidic functional groups as the binder and uses the carbon nanotubes and the macromolecules in the predetermined weight ratio. Thus, the negative electrode is able to improve dispersibility of the negative electrode active material, the carbon nanotubes, and the macromolecules and allows for efficient electron transfer. As a result, there is obtained a nonaqueous electrolyte secondary battery that even if charge and discharge are repeated, generates less gas and that has excellent cycle stability as well as high input/output characteristics.

### DESCRIPTION OF EMBODIMENTS

Hereinafter, the present invention will be described using one embodiment.

### <Negative Electrode>

A negative electrode for nonaqueous electrolyte secondary batteries according to the present invention includes a conductive aid, a binder, and a negative electrode active material.

The conductive aid according to the present invention contains 0.05 percent by weight or more and 2 percent by weight or less of carbon nanotubes having a diameter of 100 nm or less with respect to the total weight of the negative electrode active material, conductive aid, and binder.

The diameter of the carbon nanotubes according to the present invention refers to the length of the long axis of a cross section perpendicular to the length direction of each carbon nanotube having a tubular structure.

The diameter of the carbon nanotubes is preferably 50 nm or less, more preferably 30 nm or less, and particularly preferably 15 nm or less because conductivity is improved.

The diameter of the carbon nanotubes only has to be 100 nm or less regardless of the production method. Any of multilayer carbon nanotubes and monolayer carbon nanotubes are suitably used. The carbon nanotubes may be of one type, or may be a combination of two types.

Typical carbon nanotubes having a length of about 1 to 100 μm are suitably used. In particular, the length is preferably 5 μm or more, more preferably 15 μm or more, and particularly preferably 30 μm or more since input/output characteristics are improved.

The content of the carbon nanotubes is preferably 0.05 percent by weight or more and 2 percent by weight or less with respect to the total weight of the negative electrode active material, conductive aid, and binder in the negative electrode. One point five percent by weight or less is preferable in terms of the suppression of gas generation, 0.08 percent by weight or more is preferable because good input/output characteristics are obtained, and 0.1 percent by weight or more and 1 percent by weight or less is particularly preferable because excellent balance between battery characteristics is obtained.

To enhance the affinity with macromolecules having acidic functional groups (to be discussed later) or the negative electrode active material, the surface of the carbon nanotubes may be functionalized.

To control battery characteristics, the negative electrode may include conventionally known multiple conductive aids, such as acetylene black, Ketjen black, and graphite.

The reason why the carbon nanotubes having the above diameter are preferable seems to be the following: spherical acetylene black, which is a typical conductive aid, has a diameter of about 40 nm and constructs a good conductive network by forming an aggregate in which many particles are connected, called a structure; the structure is formed of many particles and has a complex and large shape and therefore a certain amount of acetylene black is required to form a good conductive network; and the carbon nanotubes have a tubular structure and a shape corresponding to the structure of acetylene black and therefore can construct a good conductive network.

However, if carbon nanotubes having a diameter of more than 100 nm are used, such carbon nanotubes tend to become larger in size than the structure formed by acetylene black. Accordingly, the used amount of such carbon nanotubes required to effectively connect the active materials to form a good conductive network seems to tend to become larger than the used amount of acetylene black. Thus, side reaction points on the surface would be increased, resulting in an increase in the amount of generated gas. On the other hand, if carbon nanotubes having a predetermined diameter or less are used, a conductive network capable of achieving efficient electron transfer can be constructed in a smaller used amount. Thus, an increase in the number of reaction points on the surface can be controlled to some extent. Such carbon nanotubes are estimated to suppress side reactions with the electrolyte and thus to reduce the amount of generated gas.

The binder contains 2 percent by weight or more and 8 percent by weight or less of macromolecules having acidic functional groups with respect to the total weight of the negative electrode active material, conductive aid, and binder.

The macromolecules having acidic functional groups are, for example, macromolecules in which acidic functional groups are added to polyvinylidene fluoride (PVdF), polytetrafluoroethylene (PTFE), styrene-butadiene rubber (SBR), polyvinylpyrrolidone (PVP), or polyimide, or at least one type of macromolecules selected from the group consisting of polyacrylic acid and derivatives thereof.

The binder may contain macromolecules having no acidic functional group.

Examples of the acidic functional groups include carboxy groups (—COOH), sulfone groups (—SO3H), and phosphate groups (—OPO3H2), and carboxy groups are preferable.

The macromolecules having the acidic functional groups used as the binder according to the present invention can be produced, for example, by a method of graft-polymerizing macromolecules having no acidic functional group and macromolecules having acidic functional groups, a method of modifying macromolecules having no acidic functional group with a compound having acidic functional groups, a method of polymerizing monomers having acidic functional groups, a method of copolymerizing monomers having acidic functional groups and monomers having no acidic functional group, or the like.

As the ratio of the acidic functional groups contained in the macromolecules, the ratio of monomers having functional groups to the total amount of monomers forming the macromolecules is preferably 1/2000 to 1/100, more preferably 1/1500 to 1/150, and 1/1000 to 1/200 is particularly preferable because excellent balance between battery characteristics is obtained. The content of the binder with respect to the total weight of the negative electrode active material, conductive aid, and binder in the negative electrode is preferably 2 percent by weight or more and 10% by weight or less, more preferably 2 percent by weight or more and 8 percent by weight or less, and 3% by weight or more and 7% by weight or less is particularly preferable because excellent balance between battery characteristics is obtained.

It is preferable in terms of dispersibility that the macromolecules having the acidic functional groups be contained in the negative electrode with a weight that is three times or more the weight of the carbon nanotubes having a diameter of 100 nm or less.

Macromolecules having no acidic functional group are hydrophobic and have high affinity with carbon nanotubes, which are also hydrophobic. For this reason, carbon nanotubes, or such macromolecules and carbon nanotubes tend to form aggregates. This results in a failure to form a favorable conductive network between the active materials and thus an increase in resistance, a reduction in binding properties, and deterioration of battery characteristics, such as input/output characteristics and cycle characteristics. On the other hand, the macromolecules having the acidic functional groups are amphiphilic. For this reason, the presence of the macromolecules having such a property in a certain amount seems to allow for dispersing the carbon nanotubes and the active material in a well-balanced manner while preventing aggregation of the hydrophobic carbon nanotubes. However, the macromolecules in an excessively large amount would inhibit an efficient electron transfer reaction between the carbon nanotubes and the active material. This may lead to not only deterioration of input/output characteristics or cycle characteristics but also adverse effects, such as a failure to obtain a sufficient capacity.

With respect to the negative electrode active material, the average operating potential thereof during desorption and insertion of lithium ions is preferably 0.5 V (vs. Li/Li⁺) or more and less than 2.0 V (vs. Li/Li⁺). The negative electrode active material preferably contains at least one of a titanium-containing oxide and a metal-organic framework.

Preferred examples of the titanium-containing oxide include a titanic acid compound, lithium titanate, and titanium dioxide. The titanium-containing compound may contain an element other than titanium, such as lithium or niobium (Nb), in a trace amount.

The titanic acid compound is preferably H₂Ti₃O₇, H₂Ti₄O₉, H₂Ti₅O₁₁, H₂Ti₆O₁₃, or H₂Ti₁₂O₂₅, and H₂Ti₁₂O₂₅ is more preferable because cycle characteristics are stable.

The lithium titanate is preferably lithium titanate having a spinel structure or ramsdellite structure and is preferably represented by a molecular formula of Li₄Ti₅O₁₂. The reason why a spinel structure is preferable is that it reduces expansion and contraction of the active material in the insertion/desorption reaction of lithium ions.

Examples of the titanium dioxide include bronze (B) titanium dioxide, anatase titanium dioxide, and ramsdellite titanium dioxide. It is particularly preferable that the titanium compound be Li₄Ti₅O₁₂ because the irreversible capacity is small and the cycle stability is excellent.

The titanium compound may be of one type, or may be a combination of two or more types.

Examples of the metal-organic compound include alkali metal salts of carboxylic acid anions having an aromatic ring structure in the organic skeleton layer. Examples of the aromatic ring structure include benzene, biphenyl, terphenyl, and the like. The aromatic ring structure may be a fused polycyclic structure, such as naphthalene, anthracene, or pyrene. The number of aromatic rings in the organic skeleton is preferably 1 to 5 in terms of energy density and stability. Preferably, each molecule includes two or more carboxylic acid anion sites, and those carboxylic acid anion sites are preferably located at diagonal positions in the organic skeleton layer. Examples of the diagonal positions include the 1st and 4th positions for benzene, the 2nd and 6th positions for naphthalene, and the 2nd and 7th positions for pyrene. To control charge-discharge performance, a substituent may be introduced into the organic skeleton layer. Preferable examples of the substituent include lithium terephthalate, lithium 2,6-naphthalenedicarboxylate, and lithium 2,7-pyrenedicarboxylate.

A method for producing the negative electrode may be a conventionally known method. Examples include a method of producing a negative electrode including a negative electrode active material layer by kneading a negative electrode active material, a conductive aid, a binder, and a solvent to produce a slurry, then supporting the slurry on a collector, and removing the solvent.

The thickness of the negative electrode active material layer is preferably 10 μm or more and 200 μm or less.

The density of the negative electrode active material layer is preferably 0.5 g/cm³ or more and 3.0 g/cm³ or less, more preferably 0.7 g/cm³ or more and 2.7 g/cm³ or less, even more preferably 1.0 g/cm³ or more and 2.5 g/cm³ or less.

When the density of the negative electrode active material layer is 1.0 g/cm³ or more, the contact between the conductive aid and the negative electrode active material is improved; when the density of the negative electrode active material layer is 3.0 g/cm³ or less, a nonaqueous electrolyte easily penetrates the negative electrode.

The density of the negative electrode active material layer may be controlled by compressing the negative electrode.

Preferable compression methods include roll press and hydraulic press.

The collector is a member that collects electrons from a positive electrode active material or the negative electrode active material.

The negative electrode may be formed by forming the same active material layer on one or both surfaces of the collector, or may be formed by forming a positive electrode active material layer on one surface of the collector and forming a negative electrode active material layer on the other surface, that is, may be a bipolar electrode.

The thickness of the collector is not limited to a particular thickness, but is preferably 10 μm or more and 100 μm or less.

Examples of the collector include copper, nickel, aluminum and alloys thereof. The collector is preferably aluminum or an alloy thereof in terms of corrosion resistance and weight, or preferably high-purity aluminum represented by JIS standard 1030, 1050, 1085, 1N 90, 1N 99, or the like, or an alloy thereof.

### <Positive Electrode>

A positive electrode includes a positive electrode active material that allows for insertion and desorption of lithium ions so that a nonaqueous electrolyte secondary battery is charged and discharged.

The average operating potential of the positive electrode active material is preferably 3.0 V (vs. Li/Li⁺) or more and 4.5 V (vs. Li/Li⁺) or less. The positive electrode active material is not limited to a particular material and may be, for example, a metal oxide or a lithium-transition metal composite oxide. Examples of the lithium-transition metal composite oxide include a lithium-transition metal composite oxide having a layered rock salt structure or a spinel structure. Spinel lithium manganate represented by Formula 2 is preferable because it exhibits good cycle characteristics.

Li₁₊ₓM_{y}Mn_{2-x-y}O₄ (2)

where 0≤x≤0.2; 0<y≤0.6; and M includes at least one element selected from the group consisting of elements belonging to one of groups 2 to 13 and period 3 or 4 (except for Mn).

With respect to spinel lithium manganate, M in Formula (1) is preferably Al, Mg, Zn, Ni, Co, Fe, Ti, Cu, Zr or Cr because a large positive electrode active material stability improvement effect is obtained, more preferably Al, Mg, Zn, Ti or Ni because a particularly large positive electrode active material stability improvement effect is obtained.

Spinel lithium manganate has a high average voltage and a good energy density. For this reason,

Li₁₊ₓAl_{y}Mn_{2-x-y}O₄ (0≤x≤0.1, 0<y≤0.1),
Li₁₊ₓMg_{y}Mn_{2-x-y}O₄ (0≤x≤0.1, 0<y≤0.1),
Li₁₊ₓZn_{y}Mn_{2-x-y}O₄ (0≤x≤0.1, 0<y≤0.1), or
Li₁₊ₓCr_{y}Mn_{2-x-y}O₄ (0≤x≤0.1, 0<≤y≤0.1) is preferable.
Li₁₊ₓAl_{y}Mn_{2-x-y}O₄ (0≤x≤0.1, 0<y≤0.1),
Li₁₊ₓMg_{y}Mn_{2-x-y}O₄ (0≤x≤0.1, 0<y≤0.1) or is more preferable.
Li₁₊ₓAl_{y}Mn_{2-x-y}O₄ (0≤x≤0.1, 0<y≤0.1) is even more preferable.

Olivine lithium manganese phosphate having a large capacity and represented by Formula (2) is also preferable as the positive electrode active material.

Li₁₊ₐMbMn_{1-a-b}PO₄ (2)

where 0≤a≤0.1; 0≤b≤0.3; and M includes at least one element selected from the group consisting of elements belonging to one of groups 2 to 13 and period 3 or 4 (except for Mn).

Further, M in the formula (2) is preferably Al, Mg, Zn, Ni, Co, Fe, Ti, or Zr, more preferably Al, Mg, Zn, Ti, or Fe because a large electrical characteristic improvement effect is obtained.

Olivine lithium manganese phosphate has a good balance between battery characteristics and energy density. For this reason,

Li₁₊ₐMg_{b}Mn_{1-a-b}PO₄ (0≤a≤0.1, 0≤b≤0.3),
Li₁₊ₐAl_{b}Mn_{1-a-b}PO₄ (0≤a≤0.1, 0≤b≤0.3),
Li₁₊ₐFe_{b}Mn_{1-a-b}PO₄ (0≤a≤0.1, 0≤b≤0.3), or
Li₁₊ₐMg_{c}Fe_{b-c}Mn_{1-a-b}PO₄ (0≤a≤0.1, 0≤b≤0.3, 0≤c≤0.1), is more preferable.

It is preferred to properly select the positive electrode active material from among these positive electrode active materials considering battery performance obtained by combining the positive electrode active material and negative electrode active material. Also, these positive electrode active materials may be used in combination.

The positive electrode may include a conductive aid or a binder.

Preferable conductive aids include a metal material and a carbon material. Preferable metal materials include copper and nickel. Examples of the carbon material include natural graphite, artificial graphite, carbon nanotubes, and carbon blacks, such as acetylene black, Ketjen black, and furnace black. The amount of the conductive aid included in the positive electrode is preferably 1 part by weight or more and 30 parts by weight or less, more preferably 2 parts by weight or more and 15 parts by weight or less with respect to 100 parts by weight of the active material. As long as the amount of the conductive aid is within the above range, the conductivity of the positive electrode is ensured. Also, the adhesiveness between the conductive aid and the binder (to be discussed later) is maintained, and sufficient adhesiveness between the conductive aid and the collector can be obtained.

These conductive aids may be used singly or in combination of two or more types.

The binder is, for example, macromolecules selected from the group consisting of polyvinylidene fluoride (PVdF), polytetrafluoroethylene (PTFE), styrene-butadiene rubber (SBR), polyimide, and derivatives thereof.

The binder included in the positive electrode may be the above-mentioned macromolecules having the acidic functional groups used in the negative electrode, or may be macromolecules having different acidic functional groups. Macromolecules having no acidic functional group and macromolecules having acidic functional groups may be used in combination.

The amount of the binder is preferably 1 part by weight or more and 30 parts by weight or less, more preferably 2 parts by weight or more and 15 parts by weight or less with respect to 100 parts by weight of the positive electrode active material. As long as the amount of the binder is within the above range, the adhesiveness between the positive electrode active material and the conductive aid is maintained and sufficient adhesiveness between the positive electrode active material and the collector is also ensured.

A method for producing the positive electrode may be a known method. For example, there may be used a method of producing a positive electrode including a positive electrode active material layer by kneading a positive electrode active material, a binder, a conductive aid, and a solvent to prepare a positive electrode slurry, then supporting the positive electrode slurry on a collector, and removing the solvent.

As used herein, the positive electrode active material layer refers to a layer that is a layer in the positive electrode and that includes a positive electrode active material contributing to insertion and desorption of lithium ions in the positive electrode.

The thickness of the positive electrode active material layer is preferably 10 μm or more and 200 μm or less.

The density of the positive electrode active material layer is preferably 1.0 g/cm³ or more and 4.0 g/cm³ or less, more preferably 1.5 g/cm³ or more and 3.5 g/cm³ or less, even more preferably 2.0 g/cm³ or more and 3.0 g/cm³ or less.

When the density of the positive electrode active material layer is 1.0 g/cm³ or more, the contact between the conductive aid and the positive electrode active material is favorable; when the density of the positive electrode active material layer is 4.0 g/cm³ or less, the nonaqueous electrolyte easily penetrates the positive electrode.

The density of the positive electrode active material layer may be controlled by compressing the positive electrode.

Preferable compression methods include roll press and hydraulic press.

Examples of the collector include nickel, aluminum, and alloys thereof, and aluminum or an alloy thereof is preferable in terms of corrosion resistance and weight. Specifically, high-purity aluminum represented by JIS standard 1030, 1050, 1085, 1N90, 1N99, or the like, or an alloy thereof is preferable. The positive electrode may be formed by forming the same active material layer on one or both surfaces of the collector, or may be formed by forming a positive electrode active material layer on one surface of the collector and forming a negative electrode active material layer on the other surface, that is, may be a bipolar electrode.

### <Nonaqueous Electrolyte>

The nonaqueous electrolyte mediates ion conduction between the negative electrode and the positive electrode. The nonaqueous electrolyte contains at least a nonaqueous solvent and an electrolyte. The nonaqueous solvent is preferably an aprotic solvent or an aprotic polar solvent, more preferably an aprotic polar solvent. Examples include carbonates, esters, lactones, sulfones, nitriles, and ethers. Specific examples include ethylene carbonate, fluoroethylene carbonate, butylene carbonate, dimethyl carbonate, ethyl methyl carbonate, dipropyl carbonate, methyl propyl carbonate, acetonitrile, γ-butyrolactone, 1,2-dimethoxyethane, sulfolane, dioxolane, and methyl propionate.

To control the balance between the viscosity, solubility, lithium-ion conductivity, and the like, two or more of these solvents may be used in a mixed manner.

The electrolyte contains, as a lithium salt, LiPF₆, LiClO₄, LiBF₄, LiAsF₆, LiCF₃SO₃, LiBOB (lithium bis(oxalato)borate), Li[N(SO₂CF₃)₂], Li[N(SO₂C₂F₅)₂], Li[N(SO₂F)₂], Li[N(CN)₂], or the like. The concentration of the lithium salt is preferably 0.5 mol/L or more and 1.5 mol/L or less.

The nonaqueous electrolyte may be previously impregnated into the positive electrode, the negative electrode, and a separator, or may be added to a laminate formed by installing a separator between the positive electrode and the negative electrode.

The nonaqueous electrolyte may be an electrolytic solution obtained by dissolving an electrolyte in a nonaqueous solvent, or may be a gel electrolyte obtained by impregnating macromolecules with an electrolytic solution obtained by dissolving an electrolyte in a nonaqueous solvent.

The amount of the nonaqueous electrolyte is properly controlled in accordance with the areas of the positive electrode, negative electrode, and separator, the amounts of the active materials, and the volume of the battery.

The nonaqueous electrolyte may include an additive, such as a flame retardant. Examples of the flame retardant include tris(2,2,2-trifluoroethyl)phosphate and ethoxy(pentafluoro)cyclotriphosphazene, and examples of the additive include vinylene carbonate, 1,3-propane sultone, and succinonitrile.

### <Separator>

The separator is disposed between the positive electrode and the negative electrode. The separator serves as a medium that mediates conduction of lithium ions therebetween while blocking conduction of electrons and holes therebetween. The separator is at least non-electron/hole conductive.

The separator is preferably nylon, cellulose, polysulfone, polyethylene, polypropylene, polybutene, polyacrylonitrile, polyimide, polyamide, polyethylene terephthalate, or a composite of two or more thereof.

The separator may have any shape as long as it is disposed between the positive electrode and the negative electrode, is insulative, and can be impregnated with the nonaqueous electrolyte. The separator is preferably a woven fabric, a nonwoven fabric, a microporous membrane, or the like.

The separator may include a plasticizer, an antioxidant, or a flame retardant, or may be coated with a metal oxide or the like.

The thickness of the separator is preferably 10 μm or more and 100 μm or less, more preferably 12 μm or more and 50 μm or less.

The porosity of the separator is preferably 30% or more and 90% or less, 35% or more and 85% or less are more preferable because the balance between the lithium-ion diffusibility and the short circuit prevention property is good, and 40% or more and 80% or less are even more preferable because the balance is particularly good.

### <Nonaqueous Electrolyte Secondary Battery>

A nonaqueous electrolyte secondary battery according to the present invention includes the negative electrode, the positive electrode, the separator interposed between the positive electrode and the negative electrode, the nonaqueous electrolyte, and an exterior material. Terminals are electrically connected to the positive electrode and the negative electrode, and each terminal has a terminal extension portion extending to the outside of the exterior material. The exterior material is a member in which a laminate formed by alternately laminating or winding the positive electrode, the negative electrode, and the separator, and the terminals electrically connected to the laminate are enclosed.

To obtain a desired voltage value and battery capacity, the number of layers of the laminate may be properly controlled. The exterior material is preferably a composite film formed by disposing a thermoplastic resin layer for heat sealing on a metal foil, a metal layer formed by vapor deposition or sputtering, or a square, elliptical, cylindrical, coin-shaped, button-shaped, or sheet-shaped metal can.

Multiple nonaqueous electrolyte secondary batteries may be connected to form an assembled battery.

### EXAMPLES

Hereinafter, the present invention will be described more specifically with reference to Examples. However, the present invention is not limited to these Examples.

### Example 1

A positive electrode slurry was prepared by mixing spinel lithium manganate (Li_{1.1}Al_{0.1}Mn_{1.8}O₄) as a positive electrode active material, acetylene black as a conductive aid, and PVdF as a binder such that the respective solid content concentrations become 100 parts by weight, 5 parts by weight, and 5 parts by weight.

The binder used was one prepared as a 5 percent by weight N-methyl-2 pyrrolidone (NMP) solution.

Then, the positive electrode slurry was diluted with NMP, and a coating of the resulting slurry was applied to one surface of a 20-μm-thick aluminum foil and then dried in an oven at 120° C. Then, a coating was also applied to the back surface and dried in a similar manner, and further dried under vacuum at 170° C.

A positive electrode was obtained through the above steps. The capacity of the positive electrode was 1.0 mAh/cm², and the area of one surface of the positive electrode was 50 cm².

Next, a negative electrode slurry was prepared by mixing spinel lithium titanate (Li_{4/3}Ti_{5/3}O₄) having an average particle size of 5 μm and a specific surface area of 4 m²/g as a negative electrode active material, carbon nanotubes having a diameter of 10 nm as a conductive aid, and PVdF having carboxy groups as a binder such that the respective solid concentrations become 100 parts by weight, 1 part by weight, and 3 parts by weight.

The binder used was one prepared as a 5 percent by weight N-methyl-2 pyrrolidone (NMP) solution.

Then, the negative electrode slurry was diluted with NMP, and a coating of the resulting slurry was applied to one surface of a 20-μm-thick aluminum foil and then dried in an oven at 120° C. Then, a coating was also applied to the back surface and dried in a similar manner, and further dried under vacuum at 170° C.

A negative electrode was obtained through the above steps. The capacity of the negative electrode was 1.2 mAh/cm², and the area of one surface of the negative electrode was 55 cm².

Next, 13 positive electrodes, 14 negative electrodes, and 28 cellulose nonwoven fabric separators were laminated in the order of separator/negative electrode/separator/positive electrode/separator/negative electrode/separator. The separator had a thickness of 25 μm and an area of 60 cm².

A laminate was obtained through the above steps.

Next, terminals were mounted on the positive electrode and the negative electrode, the laminate was sandwiched between two aluminum laminate films, and three sides of the aluminum laminate films were subjected to a heat welding step at 180° C. for 7 seconds twice.

Then, 10 mL of a nonaqueous electrolyte consisting of a mixed solvent that includes LiPF₆ as a lithium salt and in which nonaqueous solvents are mixed at a volume ratio of PC:DEC=30:70 was impregnated into the laminate. Then, the aluminum laminate films were sealed by subjecting the remaining one side to a heat welding step at 180° C. for 7 seconds twice while reducing the pressure.

A nonaqueous electrolyte secondary battery was obtained through the above steps.

### Evaluation of Input/Output Characteristics of Nonaqueous Electrolyte Secondary Battery

A nonaqueous electrolyte secondary battery produced in each Example was connected to a charge/discharge device (HJ 1005 SD8 available from HOKUTO DENKO CORPORATION), subjected to an aging step, and then charged and discharged.

In the aging step, the nonaqueous electrolyte secondary battery was fully charged, then left at 60° C. for 168 hours, and then gradually cooled to room temperature (25° C.)

After the aging step, a pulse charge-discharge test (500 mA×10 s, 1000 mA×10 s, 2000 mA×10 s, 5000 mA×10 s) was performed under an environment of 25° C. while changing the capacity from 10% to 90% in steps of 10%, and input/output characteristics were obtained from the amount of change in voltage during the pulse charge-discharge test (Table 1).

Criteria for Evaluating Input/Output Characteristics of Nonaqueous Electrolyte Secondary Batteries

If maximum input characteristics and maximum output characteristics obtained at each capacity are 50 W or more and 90 W or more, respectively, a nonaqueous electrolyte secondary battery having characteristics was evaluated as good (Table 1).

### Evaluation of Cycle Characteristics of Nonaqueous Electrolyte Secondary Batteries

A nonaqueous electrolyte secondary batteries produced in each Example was connected to a charge/discharge device (HJ 1005 SD8 available from HOKUTO DENKO CORPORATION), subjected to an aging step, and then charged and discharged.

In the aging step, the nonaqueous electrolyte secondary battery was fully charged, then left at 60° C. for 168 hours, and then cooled to room temperature (25° C.)

After the aging step, 500 mA constant current charge and 1000 mA constant current discharge were repeated 200 times under an environment of 45° C. The end-of-charge voltage and the end-of-discharge voltage were set to 2.7 V and 2.0 V, respectively.

The ratio of the 200th discharge capacity to the first discharge capacity was defined as a capacity retention rate. For example, assuming that the first discharge capacity is 100, if the 200th discharge capacity is 80, the capacity retention rate is 80%.

Moreover, the amount of gas generated in a cycle test was measured. The amount of generated gas was measured by the Archimedes method using an electronic densimeter (MDS-3000 available from Alfa Mirage Co., Ltd.).

### Criteria for Evaluating Cycle Characteristics of Nonaqueous Electrolyte Secondary Batteries

If the 200th capacity retention rate is 80% or more and the amount of gas generated after 200 cycles is less than 4.0 cc, a nonaqueous electrolyte secondary battery having such characteristics was evaluated as good; if the capacity retention rate is less than 80% and the amount of gas generated after 200 cycles is 4.0 cc or more, a nonaqueous electrolyte secondary battery such characteristics was evaluated as poor (Table 1).

### Example 2 to 15

Nonaqueous electrolyte secondary batteries were produced as in Example 1 except that the carbon nanotubes and binder of a negative electrode and the used amounts thereof were changed in accordance with Table 1.

### Example 16

A nonaqueous electrolyte secondary battery was produced as in Example 1 except that 2 parts by weight of acetylene black was further added during formation of a negative electrode.

### Comparative Examples 1 to 5

Nonaqueous electrolyte secondary batteries were produced as in Example 1 except that the carbon nanotubes and binder of a negative electrode and the used amounts thereof were changed in accordance with Table 1.

TABLE 1

| | | | | | Ratio by weight | | | | |
|---|---|---|---|---|---|---|---|---|---|
| | | | | | (weight ratio) | | | | |
| | Carbon nanotubes | | Binder | | Weight of | | | Max- | Max- |
| | | Use amounts | | Use amounts | binder/Weight | Capacity | Gas | imum | imum |
| | | (parts by | | (parts by | of carbon | retention | generation | input | output |
| | Diameter | weight) | Material | weight) | nanotubes | rate | amount | (W) | (W) |
| Example 1 | 10 nm | 1.00 | PVdF having a carboxy group | 3 | 3 | 95% | 2 cc | 70 | 110 |
| Example 2 | 10 nm | 0.50 | PVdF having a carboxy group | 2 | 4 | 93% | 1.8 cc | 62 | 101 |
| Example 3 | 10 nm | 2.00 | PVdF having a carboxy group | 6 | 3 | 92% | 2.4 cc | 71 | 112 |
| Example 4 | 5 nm | 0.05 | PVdF having a carboxy group | 2 | 40 | 90% | 1.7 cc | 60 | 98 |
| Example 5 | 5 nm | 0.10 | PVdF having a carboxy group | 2 | 20 | 94% | 2.1 cc | 62 | 102 |
| Example 6 | 5 nm | 0.20 | PVdF having a carboxy group | 3 | 15 | 92% | 1.9 cc | 65 | 105 |
| Example 7 | 15 nm | 1.00 | PVdF having a carboxy group | 3 | 3 | 90% | 2.4 cc | 69 | 107 |
| Example 8 | 30 nm | 1.00 | PVdF having a carboxy group | 3 | 3 | 88% | 3.0 cc | 62 | 99 |
| Example 9 | 50 nm | 2.00 | PVdF having a carboxy group | 6 | 3 | 86% | 3.3 cc | 59 | 95 |
| Example 10 | 80 nm | 2.00 | PVdF having a carboxy group | 6 | 3 | 83% | 3.7 cc | 57 | 92 |
| Example 11 | 100 nm | 2.00 | PVdF having a carboxy group | 6 | 3 | 83% | 3.9 cc | 53 | 90 |
| Example 12 | 10 nm | 1.00 | PVdF having a carboxy group | 3 | 3 | 93% | 2.2 cc | 64 | 105 |
| Example 13 | 10 nm | 1.00 | PVdF having a carboxy group | 3 | 3 | 91% | 2.8 cc | 60 | 96 |
| Example 14 | 10 nm | 1.00 | PVdF having a carboxy group | 3 | 3 | 89% | 3.0 cc | 53 | 93 |
| Example 15 | 10 nm | 1.00 | PVdF having a phosphate group | 3 | 3 | 88% | 3.3 cc | 58 | 94 |
| Example 16 | 10 nm | 1.00 | PVdF having a carboxy group | 3 | 3 | 94% | 3.2 cc | 72 | 115 |
| Comparative | 150 nm | 2.00 | PVdF having a carboxy group | 6 | 3 | 76% | 4.5 cc | 40 | 80 |
| Example 1 | | | | | | | | | |
| Comparative | 5 nm | 0.01 | PVdF having a carboxy group | 2 | 200 | 77% | 1.9 cc | 39 | 75 |
| Example 2 | | | | | | | | | |
| Comparative | 5 nm | 0.05 | PVdF having a carboxy group | 1 | 20 | 70% | 1.5 cc | 41 | 85 |
| Example 3 | | | | | | | | | |
| Comparative | 10 nm | 1.00 | PVdF having a carboxy group | 2 | 2 | 78% | 2.8 cc | 42 | 84 |
| Example 4 | | | | | | | | | |
| Comparative | 10 nm | 1.00 | PVdF | 3 | 3 | 71% | 2.5 cc | 38 | 81 |
| Example 5 | | | | | | | | | |

In Example 1 to 16, there were obtained batteries that suppress gas generation and have less capacity retention rate reduction and excellent cycle stability as well as high input/output characteristics. The reason seems to be that the produced favorable negative electrodes allowed for efficient electron transfer between the active material and the conductive aid and thus a reduction in side reactions associated with charge and discharge. On the other hand, in Comparative Example 1 to 5, large amounts of gas were generated, the capacity retention rates were low, and high input/output characteristics were not obtained. The reason seems to be that the obtained batteries did not satisfy the evaluation criteria due to the use of the negative electrode not satisfying the predetermined conditions.

1. A negative electrode for nonaqueous electrolyte secondary batteries, comprising:
a negative electrode active material;
a conductive aid; and
a binder, wherein
the negative electrode active material has an average operating potential of 0.5 V vs. Li/Li⁺ or more and less than 2.0 V vs. Li/Li⁺ during desorption and insertion of lithium ions,
the conductive aid contains 0.05 percent by weight or more and 2 percent by weight or less of carbon nanotubes having a diameter of 100 nm or less with respect to the total weight of the negative electrode active material, the conductive aid, and the binder, and
the binder contains 2 percent by weight or more and 8 percent by weight or less of macromolecules having acidic functional groups with respect to the total weight of the negative electrode active material, the conductive aid, and the binder.

2. The negative electrode for nonaqueous electrolyte secondary batteries according to claim 1, wherein the conductive aid is carbon nanotubes having a diameter of 50 nm or less.

3. The negative electrode for nonaqueous electrolyte secondary batteries according to claim 1, wherein the weight of the macromolecules having the acidic functional groups is 3 times or more and less than 50 times the weight of the carbon nanotubes included in the negative electrode for nonaqueous electrolyte secondary batteries.

4. The negative electrode for nonaqueous electrolyte secondary batteries according to claim 1, wherein the negative electrode active material contains at least one of a titanium-containing oxide and a metal-organic compound.

5. The negative electrode for nonaqueous electrolyte secondary batteries according to claim 1, wherein the macromolecules having the acidic functional groups are polyvinylidene fluoride, polyvinyl pyrrolidone, styrene-butadiene rubber, or polyacrylic acid.

6. A nonaqueous electrolyte secondary battery using the negative electrode according to claim 1.
